(19) United States
(12) Patent Application Publication
(10) Pub. No.: US 2026/0068919 A1
(43) Pub. Date: Mar. 12, 2026

(54) AUTOMATIC CUTTING DEVICE FOR THREE-FLOWER TANGERINE PEEL

(71) Applicants: Zhejiang A&F University, Hangzhou (CN); Zhejiang Zaochun Agricultural Development Co., Ltd., Quzhou (CN)

(72) Inventors: Xinghua LU, Hangzhou (CN); Jiulin FENG, Hangzhou (CN); Linjiang PANG, Hangzhou (CN); Yuge GUAN, Hangzhou (CN); Jiyu CHENG, Hangzhou (CN); Mingyi YANG, Hangzhou (CN); Xiaoqiang XU, Quzhou (CN)

(73) Assignees: Zhejiang A&F University, Hangzhou (CN); Zhejiang Zaochun Agricultural Development Co., Ltd., Quzhou (CN)

(21) Appl. No.: 18/932,681

(22) Filed: Oct. 31, 2024

(30) Foreign Application Priority Data
Sep. 10, 2024 (CN) 202411260997.4

(51) Int. Cl. A23N 7/02; A23N 7/10

(52) U.S. Cl. CPC A23N 7/023; A23N 7/10

(57) ABSTRACT

An automatic cutting device for three-flower tangerine peel includes a base frame, a cutting component and a moving component are mounted on the base frame, and the moving component applies pressure to the citrus on the cutting component through a linkage component to complete the cutting of tangerine peel. The cutting component includes three sets of tool holder support columns in a surround arrangement, a spring fixed base is arranged behind the tool holder support column, an arc-shaped chute is arranged at the top of the tool holder support column, and a sliding rod is L-shaped. The sliding rod includes an active rod connected to a tool holder and a driven rod located in the chute, the driven rod is elastically connected to the spring fixed base, and a trajectory and force strength of the tool holder are controlled by a spring limit.

### CROSS REFERENCE TO THE RELATED APPLICATIONS

This application is based upon and claims priority to Chinese Patent Application No. 202411260997.4, filed on Sep. 10, 2024, the entire contents of which are incorporated herein by reference.

### TECHNICAL FIELD

The present invention relates to the technical field, in particular to an automatic cutting device for three-flower tangerine peel.

### BACKGROUND

Three-flower tangerine peel occupies an important position in people's daily diet. In terms of medicinal application, the three-flower tangerine peel has the effects of resolving phlegm and relieving cough, helping digestion, and reducing blood pressure, making it frequently appear in the formula of a medicinal diet. As more and more people pay attention to the three-flower tangerine peel, the sales of tangerine peel are also increasing, and the planting of citrus is also increasing.

At present, the production mode of tangerine peel is mainly based on small workshop production, which is basically manual peeling, and the production efficiency is low. A large amount of labor is required when tangerine peel is produced in large quantities. It is likely to rot and cause economic losses if the citrus is not treated in time; and there is no uniform hygiene standard in the manual peeling process. In order to improve productivity and efficiency in the era of automation and intelligence, the labor productivity is insufficient to keep up with the times, so it is necessary to design a mechanical device to replace and reduce the number of manual workers.

### SUMMARY

In order to solve the above problems, the present invention provides an automatic cutting device for three-flower tangerine peel, which realizes the automation and high-efficiency cutting of citrus into a three-flower shape.

In order to achieve the above objective, the present invention provides an automatic cutting device for three-flower tangerine peel, including a base frame, on which a cutting component and a moving component are mounted. The moving component applies pressure to the citrus on the cutting component through a linkage component to complete the cutting of tangerine peel.

The cutting component includes three sets of tool holder support columns in a surround arrangement, a spring fixed base is arranged behind the tool holder support column, an arc-shaped chute is arranged at the top of the tool holder support column, and a sliding rod is L-shaped, the sliding rod includes an active rod connected to a tool holder and a driven rod located in the chute, the driven rod is elastically connected to the spring fixed base, and a trajectory and force strength of the tool holder are controlled by a spring limit.

Preferably, a 2×2 knife hole is arranged in the tool holder, and a blade is detachably mounted in the knife hole.

Preferably, the base frame is provided with a discharge port at a center position of the three sets of tool holder support columns, the discharge port is fixedly provided with a deceleration net, and a storage box is arranged below the discharge port, the storage box is detachably mounted at the bottom of the base frame in a mosaic manner; a small hole is arranged under the storage box to ensure drying while increasing air permeability.

Preferably, the moving component includes a track longitudinally arranged on the base frame, a holding slot is arranged at the top of the track, a slider is arranged on the track, the track is slidingly connected to the slider, a cylindrical pin fixing hole is equidistantly arranged on the track, the cylindrical pin fixing hole and the slider are fixed by a cylindrical pin, and the cylindrical pin fixing hole and the cylindrical pin are fixed by a single cylindrical pin fixer.

Preferably, the bottom of the track is provided with a low limit slot to limit a farthest moving path of the slider, the slider is connected to the linkage component, and a height of the linkage component is adjusted by the slider.

Preferably, the linkage component includes a connecting plate and a pneumatic push rod, and the two sides of the end of the connecting plate are provided with a fixed handle and the pneumatic push rod respectively; the fixed handle is used for an auxiliary fixing when adjusting the height of the linkage component; the pneumatic push rod is connected to a rubber shock absorber, and downward and reset of the rubber shock absorber are controlled by an expansion of the pneumatic push rod.

Preferably, the top of the track is provided with a counter, and a three-digit digital turntable is arranged in the counter for a counting of citrus, and digit plus one when the pneumatic push rod performs a complete stroke.

The present invention provides an automatic cutting device for three-flower tangerine peel, which has the following beneficial effects:
(1) the pneumatic push rod drives the citrus downward, so as to apply pressure to the tool holder of the cutting component, the pressure drives the tool holder to move down and makes the sliding rod move along the chute, so that the blade moves inward and realizes the cutting of different citrus shapes and sizes and surfaces;
(2) the tool holder is divided into upper and lower double blades, so that the citrus epidermis is peeled twice in coarse and fine peelings, which can fully cut the citrus epidermis into a style of three-flower tangerine peel, and ensure the flesh damage rate, and the two rows of standardized blades in the tool holder can be quickly replaced;
(3) the pneumatic push rod can continuously and automatically press the citrus, and the citrus falls out from the discharge port, which can avoid the manual push of the cut citrus, reduce the operation risk of the workers, and improve the cutting efficiency, and the deceleration network at the bottom will also reduce the damage rate of pulp and peel;
(4) there is no need for personnel to participate in the cutting process, which ensures the safety of staff and avoids the pollution of citrus.

Further detailed descriptions of the technical scheme of the present invention can be found in the accompanying drawings and embodiments.

### BRIEF DESCRIPTION OF THE DRAWINGS

FIG. 1 is a schematic diagram of an overall structure of an automatic cutting device for the three-flower tangerine peel of the present invention;

FIG. 2 is a schematic diagram of a cutting component structure of an automatic cutting device for the three-flower tangerine peel of the present invention.

Reference numerals in figures:

1, a counter; 2, a track; 3, a connecting plate; 4, a fixed handle; 5, a pneumatic push rod; 6, a rubber shock absorber; 7, a tool holder; 8, a tool holder support column; 9, a spring fixed base; 10, a discharge port; 11, a deceleration net; 12, a storage box; 13, a chute; 14, a base frame; 15, a sliding rod; 16, a low limit slot; 17, a slider; 18, a cylindrical pin fixing hole; 19, a single cylindrical pin fixer; 20, a holding slot; 151, an active rod; 152, a driven rod.

### DETAILED DESCRIPTION OF THE EMBODIMENTS

In order to make the objective, technical solution, and advantages of the present invention clearer and more specific, the present invention will be further described in detail below with reference to accompanying drawings and embodiments. It should be understood that the specific examples described herein are merely illustrative of the present invention and are not intended to limit the present invention. All other embodiments obtained by those of ordinary skill in the art based on the embodiments of the present application without involving any creative effort shall fall within the scope of protection of the present application. Examples of the embodiments are shown in the drawings, wherein like or similar reference numerals refer to the same or similar elements or elements having the same or similar function throughout.

It should be noted that the terms “includes” and “having”, and any variations thereof, are intended to cover a non-exclusive inclusion, such that a process, method, system, product, or server that includes a series of steps or elements is not necessarily limited to those steps or elements expressly listed, but may include other steps or elements not expressly listed or inherent to such process, method, article, or device.

Similar label numbers and letters refer to like items in the following figures, and thus, once an item is defined in one figure, it need not be further defined and explained in the following figures.

### Embodiment

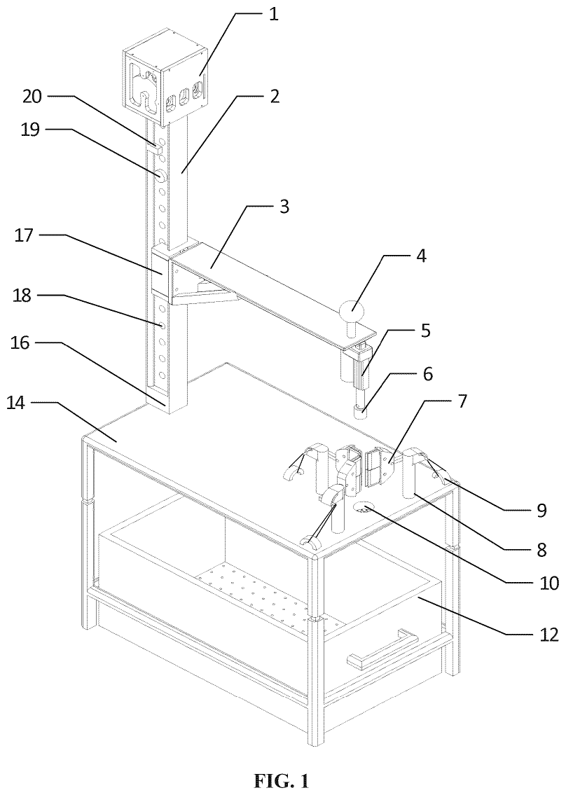

An automatic cutting device for three-flower tangerine peel, as shown in FIG. 1, including:
a base frame 14, a cutting component and a moving component are arranged at both ends of the base frame 14, and the moving component applies pressure to the citrus on the cutting component through a linkage component to complete the cutting of tangerine peel.

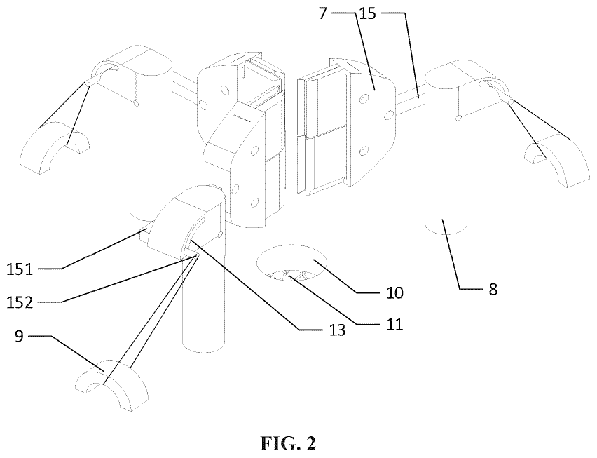

The cutting component as shown in FIG. 2, includes three sets of tool holder support columns in a surround arrangement, the adjacent tool holder support column 8 is 120°. The top of the tool holder support column 8 is connected to the tool holder 7 through a sliding rod 15, and the blade is detachably arranged on the tool holder 7.

A spring fixed base 9 is arranged behind the tool holder support column 8, and the spring fixed base 9 is connected to the sliding rod 15 through the spring. The trajectory and force strength of the tool holder 7 are controlled by a spring limit.

A 2×2 knife hole is arranged in the tool holder 7, so that the citrus epidermis is peeled twice in coarse and fine peelings, which can fully cut the citrus epidermis into a style of three-flower tangerine peel. The knife hole adopts a standardized design, and can be easily replaced at any time when damaged.

Preferably, the central position of the tool holder support column 8 is provided with a discharge port 10, the discharge port 10 is fixedly provided with a deceleration net 11, and a storage box 12 is arranged below the discharge port 10, the storage box 12 is detachably mounted at the bottom of the base frame 14 in a mosaic manner; a small hole is arranged under the storage box 12 to ensure drying while increasing air permeability.

An arc-shaped chute 13 is arranged at the top of the tool holder support column 8, and a sliding rod 15 is L-shaped, including an active rod 151 connected to a tool holder 7 and a driven rod 152 located in the chute 13, the driven rod 152 is elastically connected to the spring fixed base 9.

In the initial state of the cutting component, the spring's elastic force fixes the driven rod 152 at the lowest end of the chute 13, at this time, the tool holder 7 is at the highest end and the three tool holders 7 remain horizontal. As the linkage component applies pressure to the citrus, the tool holder 7 and the blade also move down, and the sliding rod 15 slides along chute 13, so that the three sets of blades move down and converge to the center at the same time, so as to realize the peeling and cutting treatment of the citrus surface. In the cutting process, the cutting angle will be slightly tilted with the change of the size and shape of the citrus, and the upper and lower coherent but different position angles of the blade are used for the secondary processing with first deep and then shallow, which can fully cut the citrus epidermis into a style of three-flower tangerine peel.

After the citrus is cut, it is dropped from discharge port 10, and the spring drives sliding rod 15 to reset to the initial state for the next cutting preparation.

The moving component includes a track 2 longitudinally arranged on the base frame 14, a holding slot 20 is arranged at the top of the track 2. A slider 17 is arranged on the track 2, the track 2 is slidingly connected to the slider 17, a cylindrical pin fixing hole 18 is equidistantly arranged on the track 2, the cylindrical pin fixing hole 18 and the slider 17 are fixed by a cylindrical pin, and the cylindrical pin fixing hole 18 and the cylindrical pin are fixed by a single cylindrical pin fixer 19.

The bottom of the track 2 is provided with a low limit slot 16 to limit a farthest moving path of the slider as a safety measure. The slider 17 is connected to the linkage component, and a height of the linkage component is adjusted by the slider 17.

The linkage component includes a connecting plate 3 and a pneumatic push rod 5, and the two sides of the end of the connecting plate 3 are provided with a fixed handle 4 and the pneumatic push rod 5 respectively. The fixed handle 4 is used for an auxiliary fixing when adjusting the height of the linkage component. The pneumatic push rod 5 is connected to a rubber shock absorber 6, and the downward and reset of the rubber shock absorber 6 are controlled by an expansion of the pneumatic push rod 5.

Pneumatic push rod 5 belongs to the common knowledge in this field, its working principle is a well-known technology, and its model is selected according to the actual use, so the pneumatic push rod 5 does not explain the control mode and connection mode in detail.

The top of the track 2 is provided with a counter 1, and a three-digit digital turntable is arranged in the counter 1 for a counting of citrus, and digit plus one when the pneumatic push rod 5 performs a complete stroke.

Counter 1 belongs to the common knowledge in this field, its working principle is a well-known technology, and its model is selected according to the actual use, so the counter 1 does not explain the control mode and connection mode in detail.

In the process of using the present invention, the storage box 12 is placed, firstly, the height of the linkage component is adjusted, secondly, whether the cutting component is in the initial state is checked, and the citrus cutting is started after checking; the citrus is placed in the center of the tool holder 7, and the pneumatic push rod 5 is started, the pneumatic push rod 5 drives the rubber shock absorber 6 to move down to apply pressure on the citrus, as the pneumatic push rod 5 moves downward gradually, the tool holder 7 is pushed to move downward gradually, and the driven rod 152 is gradually moved up along the chute 13, the tool holder 7 is moved inward at the same time, and the three sets of tool holder 7 are operated independently to cut the conforming citrus shape; after the whole citrus is cut, it falls from the discharge port 10 through the deceleration net 11 into the storage box 12; the pneumatic push rod 5 is reset, and the counter completes 1 count.

The present invention is an automatic cutting device for three-flower tangerine peel, which realizes the cutting of three-flower tangerine peel style of the conforming citrus shape through the linkage of cutting components and linkage components. There is no need for personnel to participate in the cutting process, which ensures the safety of staff and avoids the pollution of citrus.

Finally, it should be noted that the above examples are merely used for describing the technical solutions of the present invention, rather than limiting the same. Although the present invention has been described in detail with reference to the preferred examples, those of ordinary skill in the art should understand that the technical solutions of the present invention may still be modified or equivalently replaced. However, these modifications or substitutions should not make the modified technical solutions deviate from the spirit and scope of the technical solutions of the present invention.

What is claimed is:

1. An automatic cutting device for three-flower tangerine peel, comprising a base frame, wherein a cutting component and a moving component are mounted on the base frame, and the moving component applies pressure to a citrus on the cutting component through a linkage component to complete a cutting of the three-flower tangerine peel; and
the cutting component comprises three sets of tool holder support columns in a surround arrangement, a spring fixed base is arranged behind each set of the three sets of tool holder support columns, an arc-shaped chute is arranged at a top of each set of the three sets of tool holder support columns, and a sliding rod is L-shaped; the sliding rod comprises an active rod connected to a tool holder and a driven rod located in the arc-shaped chute, the driven rod is elastically connected to the spring fixed base, and a trajectory and force strength of the tool holder are controlled by a spring limit.

2. The automatic cutting device according to claim 1, wherein a 2×2 knife hole is arranged in the tool holder, and a blade is detachably mounted in the 2×2 knife hole.

3. The automatic cutting device according to claim 1, wherein the base frame is provided with a discharge port at a center position of the three sets of tool holder support columns, the discharge port is fixedly provided with a deceleration net, a storage box is arranged below the discharge port, and the storage box is detachably mounted at a bottom of the base frame in a mosaic manner; and a small hole is arranged under the storage box to ensure drying while increasing air permeability.

4. The automatic cutting device according to claim 1, wherein the moving component comprises a track longitudinally arranged on the base frame, a holding slot is arranged at a top of the track, a slider is arranged on the track, the track is slidingly connected to the slider, a cylindrical pin fixing hole is equidistantly arranged on the track, the cylindrical pin fixing hole and the slider are fixed by a cylindrical pin, and the cylindrical pin fixing hole and the cylindrical pin are fixed by a single cylindrical pin fixer.

5. The automatic cutting device according to claim 4, wherein a bottom of the track is provided with a low limit slot to limit a farthest moving path of the slider, the slider is connected to the linkage component, and a height of the linkage component is adjusted by the slider.

6. The automatic cutting device according to claim 5, wherein the linkage component comprises a connecting plate and a pneumatic push rod, and two sides of an end of the connecting plate are provided with a fixed handle and the pneumatic push rod respectively; the fixed handle is used for an auxiliary fixing when the height of the linkage component is adjusted; the pneumatic push rod is connected to a rubber shock absorber, and downward and reset of the rubber shock absorber are controlled by an expansion of the pneumatic push rod.

7. The automatic cutting device according to claim 5, wherein the top of the track is provided with a counter, and a three-digit digital turntable is arranged in the counter for a counting of the citrus, and digit plus one when the pneumatic push rod performs a complete stroke.
